(19) United States
(12) Patent Application Publication
(10) Pub. No.: US 2005/0102241 A1
(43) Pub. Date: May 12, 2005

(54) Method of using personal signature as postage

(76) Inventors: Jon Cook, Alexandria, VA (US); Roy R. Gordon, Gaithersburg, MD (US); Wayne A. Wilkerson, Manassas, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/450,613

(22) PCT Filed: Dec. 18, 2001
(86) PCT No.: PCT/US01/48271

Related U.S. Application Data
(60) Provisional application No. 60/255,905, filed on Dec. 18, 2000.

(51) Int. Cl. G06F 17/60

(52) U.S. Cl. 705/64

(57) ABSTRACT

A method of converting a signature into an authorization for an item of value in lieu of cash, the method including the steps of transmitting a request, comprising a digitized signature and an amount requested by the user, to a service provider with whom the user has an account; validating the request; and generating for the user an authorization wherein the authorization may be used in lieu of money in the amount authorized.

### CROSS REFERENCE TO RELATED APPLICATIONS

This application claims the benefit of provisional application “Method of Using Personal Signature as Postage,” filed Dec. 18, 2000 and assigned Ser. No. 60/255,905, the disclosure of which is expressly incorporated herein by reference.

### FIELD

The present invention relates to converting a string of characters unique to an individual to allow the individual to receive something of value back in exchange via a computer. For example an individual, may receive postage back from a company by using the individual's signature and an indicated value amount.

### BACKGROUND

Presently, a user can access existing accounts, such as accounts with postage service providers like Pitney Bowes, PSI/Envelope Manager, Stamps.com, or other PC Postage vendors, using a password or account number. This requires the user to remember a long series of numbers in order to access their account, and remember the password. Thus, users often choose passwords that are easy for them to remember, such as birth date, anniversary, etc. Choosing such a password is a security risk in that these are the numbers easy for unauthorized persons to guess or acquire. However, if a user selects a password that is not easy to remember and must be carried with him, there is the danger that an unauthorized person may come into possession of the written copy of the password.

One method of using a signature for postage is known as “franking.” Historically, franking has been available to military serving overseas and to Congressmen. For example, a Congressman can sign the upper right hand portion of an envelope, and the U.S. Postal Service will treat this signature as valid postage. However, this service is not available to the general public. Individuals must undergo an approval process to qualify as one of the select group of persons privileged to use this service.

Thus, there is a need to allow users in the general public to access existing accounts without having to carry or remember a password or account number.

### SUMMARY

Systems and methods consistent with the invention provide a way for users of existing accounts to access their account without having to carry materials with them or memorize a long series of numbers. Systems and methods for converting a signature into an authorization for use in lieu of cash including transmitting a request, comprising a digital user's signature and an amount requested by the user, to a service provider with whom the user has an account; validating the request; and generating for the user an authorization wherein the authorization may be used in lieu of money in the amount authorized.

It is to be understood that both the foregoing general description and the following detailed description are exemplary and explanatory only and are not restrictive of the invention, as claimed.

The accompanying drawings, which are incorporated in and constitute a part of this specification, illustrate several embodiments consistent with the invention and together with the description, serves to explain the principles of the invention.

### BRIEF DESCRIPTION OF THE DRAWINGS

The accompanying drawings, which are incorporated in and constitute a part of this specification, illustrate several embodiments consistent with the invention and together with the description, serve to explain the principles of the invention.

FIG. 1 is a flow chart illustrating a first exemplary method of utilizing a signature to obtain something of value consistent with the invention;

FIG. 2 is a flow chart illustrating a second exemplary method of utilizing a signature to obtain something of value consistent with the invention;

FIG. 3 is a flow chart illustrating the alternatives for digitizing a signature consistent with the invention;

FIG. 4 is a flow chart illustrating the alternatives for validating a signature consistent with the invention; and

FIG. 5 is a flow chart illustrating a an exemplary method consistent with the invention.

### DESCRIPTION OF THE PREFERRED EMBODIMENTS

Reference will now be made in detail to the exemplary embodiments, as illustrated in the accompanying drawings. Wherever possible, the same reference numbers will be used throughout the drawings to refer to the same or like parts.

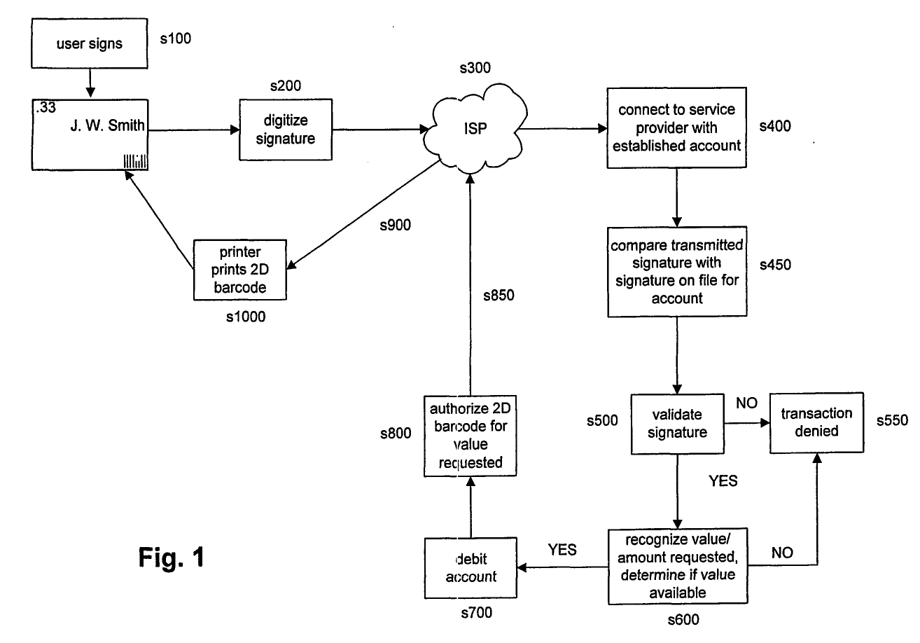

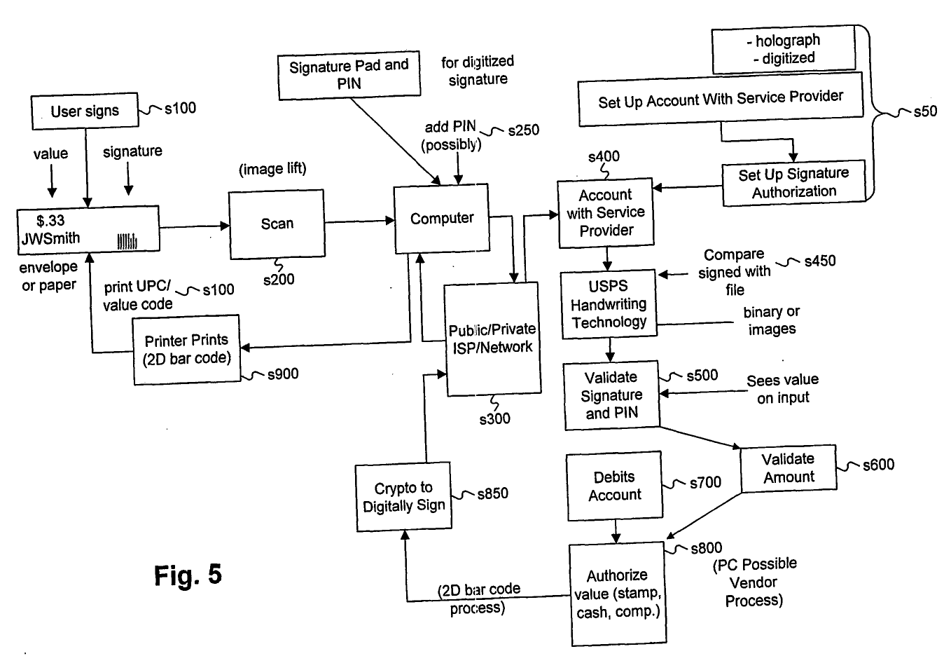

Systems and methods consistent with the invention replace a password or account number, comprising a string of numbers and/or letters that a person would have to remember in order to access an established account. The password or account number is replaced with something personal to the user that the user has with him at all times, such as his signature. The user may then receive something of value in return for his signature, such as postage, cash, or a coupon. The process works with a service provider company with whom the user has an existing account and allows the user to obtain something of value by using his signature. For example, a user having an existing account with an online postage vendor may use his signature to obtain postage (see FIGS. 1 and 5). The user deals with a company or organization with whom he has an existing account, an organization that would recognize the particular signature of the user and have a way to validate it, such as by comparison to a signature on file. The individual user may write his name and the number of the value of the stamp (for example, 0.33 for a thirty-three cent stamp), coupon or other item of value that the user wants to receive, at a location on an envelope or piece of paper, for example in the upper right hand corner (s100). Alternatively, a pressure signature pad may be provided for obtaining the user's signature.

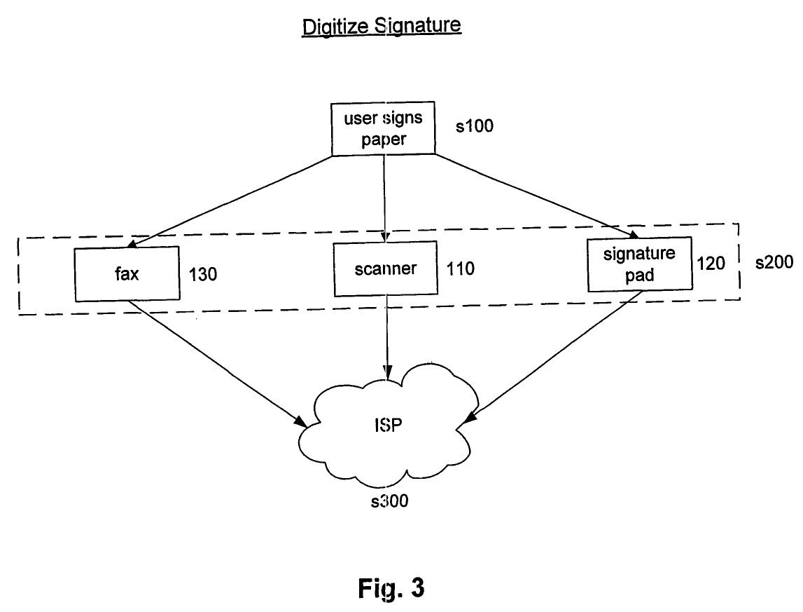

Referring to FIG. 3, the handwritten signature and the value are then digitized (s200). Digitizing can be accomplished with a scanner 110, a signature pad 120 or digital pen, or by fax machine 130. The scanner may be a sophisticated high resolution scanner such as those available at the U.S. Postal Service, or may be a scanner having less resolution but sufficient to capture the signature in enough detail so that it can transmit the signature to be digitally reproduced at a later time and then validated. Other devices having the capability to digitize a signature may also be used. In addition, a digital signature may be used to encrypt the signature of the user. Such a digital signature can use any known or later developed schemes for digitally signing information.

The digitized signature and value may optionally be further protected by a PIN (s250) (Personal Identification Number) as shown in FIG. 5. The use of a PIN is optional to the user, and may be set at the time the account is established (s50). A PIN may be used by keying numbers in a keypad or by calling the company to which the user has transmitted the scanned data (signature and value) and verbally communicating the PIN. Alternatively, the user may transmit the digital information by email or other communication channel.

The digitized information (signature, value, and optional PIN) is transferred, usually via a computer, over a public or private network (s300), such as a network with a secure link and SSL, to a company with whom the individual has established an account (s400). The company then receives the digitized data request, and validates (s500) the digitized signature (and optional PIN) using signature verification software.

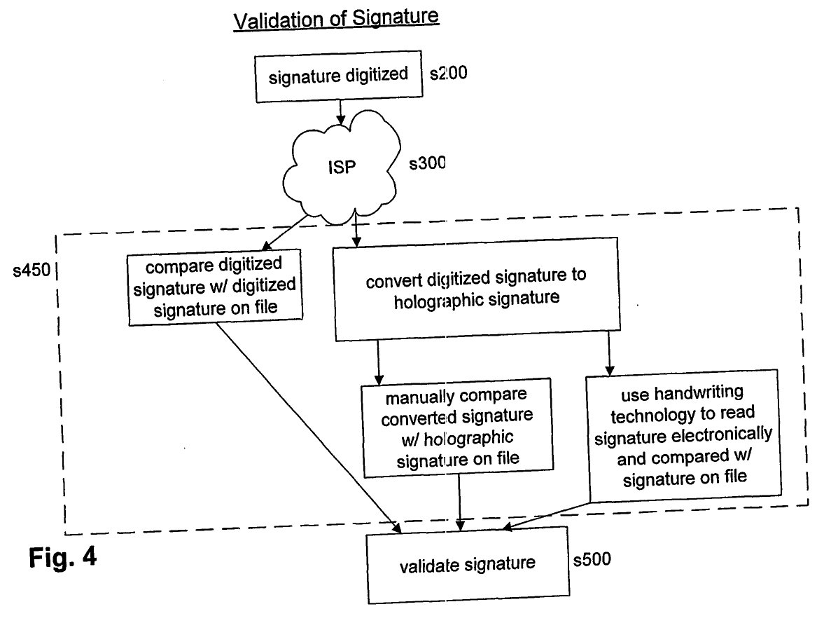

In order to recognize and validate the signature (s500), the company must already have a copy of the signature on file. The company then compares the received digital signature with the signature on file (s450). The signature may be validated in a variety of ways (FIG. 4). For example, the digitized signature transferred by the user may be compared with a digitized signature on file with the company. Alternatively, the digitized signature transferred by the user may be converted into a holographic signature. The holographic signature may then be manually compared to a holographic signature of the user kept on file. Alternatively, handwriting technology recognition software, such handwriting technology software used by the U.S. Postal Service, may be used to read the holographic signature electronically and determine if it matches with the signature on file (FIGS. 4 and 5).

If the company recognizes and validates the signature (s500), it attempts to authorize the amount/value requested (s600). The company must recognize the amount requested by the user, and must authorize the user to utilize that amount. In the case of a debit account, the user must have at least the requested amount available in his account. Once the signature is validated (s500), and the amount authorized (s600), the company will debit the individual's account (s700) for the amount indicated in the original digitized information. Once the account is debited, the company will authorize an item of value (s800), in this particular example, a stamp.

An command to print a 2D barcode representative of the value requested by the user is then transmitted back to the user by a public or private network, preferably using a secure network connection. Alternatively, instead of commanding the printing of a 2D barcode, the command may instead require the printing of the authorization using any other known or later developed data printing technique, such as a digital watermark. This command may or may not be encrypted (s850). If the signature is not validated or if the amount is not recognized or is not available in the user's account, the transaction will be denied and a message to that effect may be sent (s550) (FIG. 1).

The command sent back to the user through the network directs a printer (s900) to produce a 2D bar code (PC Postage/IBI versions), or similar data printing technique, over or adjacent to the signature (s1000) on the envelope (or piece of paper) that the individual user signed. In this example, a 2D postage barcode representative of $0.33 of postage would be printed. Alternatively, the 2D bar code could constitute a coupon for the requested value or a money order for the requested value. Thus, systems and methods consistent with the invention convert a signature of a user to something of value through a service provider.

The example described above was directed to converting the signature of the user into postage, but a user with an appropriate account set up with a service provider can request an authorization for anything of value that is offered by the service provider. For example, a coupon or money order may be requested. If an individual wanted to receive a coupon of a value for redemption at a grocery store, Post Office, bank or other organization capable of redeeming such a 2D barcode, authorization, the user may write his signature, have it digitized, send it to the service provider, and receive an authorization for the requested item of value for the amount of value.

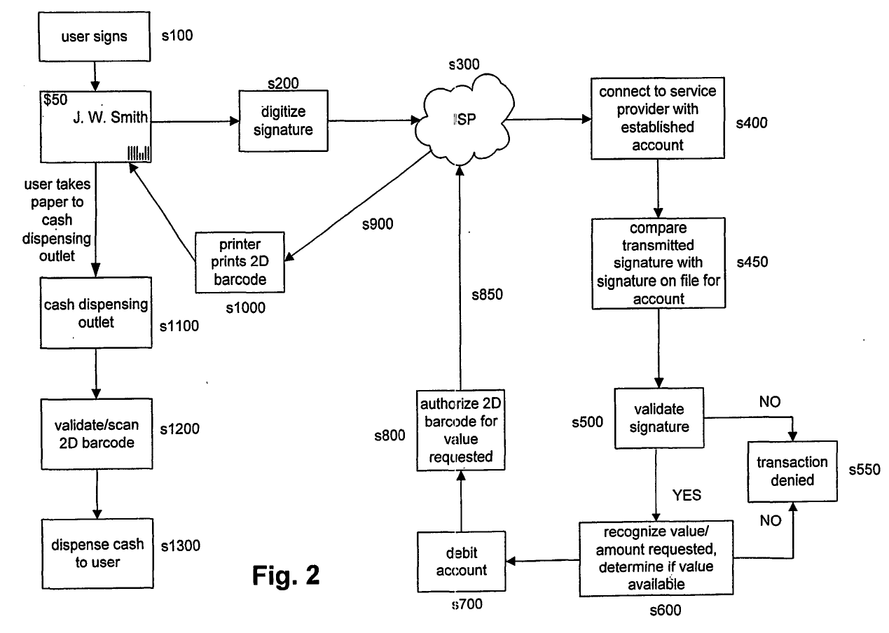

If a user desired cash, the entire process uses the person's signature and request for value number. For example, as shown in FIG. 2, where the service provider is a bank with whom the user has a relationship, the bank will recognize the users signature (s500) and authorize the printing of an authorization such as a 2D bar code on a piece of paper (s800) worth a certain amount of money. The user may then present the bar-coded paper at an appropriate cash dispensing location (s1100) and convert the paper to cash. Cash dispensing outlets willing to dispense cash for such a barcode may wish to validate the barcode to ensure it is valid (s1200). The 2D barcode generated on behalf of the service provider is unique and will never be duplicated again. In addition, the information in the 2D barcode may be digitally signed, preventing fraud and counterfeiting. Thus, the 2D barcode has unique value and establishes that it was sent from the provider to the user for a specific value. This allows a cash dispensing outlet to verify the authenticity of the 2D barcode prior to dispensing cash (s1200, s1300). Such a 2D barcode might be redeemable for cash at a retailer, a public kiosk, a bank, or a Post Office where the code might be redeemed as a money order.

A user may set up an account with a product service provider having the capability of producing unique 2D barcodes. Such barcodes are presently used by the U.S. Postal Service. Service providers presently having such capabilities include Pitney Bowes, PSI/envelope manager, and Stamps.com. Many additional providers will eventually have this capability, and a current list of approved providers may be obtained from the U.S. Postal Service. The product service provider will have technology similar to the PC Postage products and services approved by the Unites States Postal Service that uses a 2D bar code in combination with a digital signature capability such that the 2D bar code received by a user is absolutely unique.

Other embodiments will be apparent to those skilled in the art from consideration of the specification and practice of the systems and methods disclosed herein. It is intended that the specification and examples be considered as exemplary only, with a true scope and spirit of the invention being indicated by the following claims.

1. A method of converting a signature into an authorization for an item of value in lieu of cash, the method comprising:
transmitting a request, comprising a digitized signature and an amount requested by the user, to a service provider with whom the user has an account;
validating the request; and
generating for the user an authorization wherein the authorization may be used in lieu of money in the amount authorized.

2. The method of claim 1, further including:
scanning a user's signature to produce a digitized signature.

3. The method of claim 1, further including:
inputting a sign one of a pressure sensitive signature pad and a digital pad to produce a digitized signature.

4. The method of claim 1, wherein transferring further includes:
faxing a user's signature to produce a digitized signature.

5. The method of claim 1, wherein the validating includes:
comparing the digitized signature with a signature previously provided to the service provider by the user.

6. The method of claim 1, wherein the method further includes:
transmitting a PIN number to the service provider.

7. The method of claim 6, wherein validating further includes
validating the PIN number against the PIN number associated with the user's account.

8. The method of claim 1, wherein generating includes:
generating an authorization comprising a unique barcode; and
providing a copy of the authorization to the user.

9. The method of claim 1, wherein the authorization authorizes the use of the amount as postage and wherein the method includes:
printing an authorization for use as postage in the amount authorized by the service provider.

10. The method of claim 1, wherein authorization authorizes the use of the amount as a coupon, and wherein the method includes:
printing an authorization in the form of a coupon in the amount authorized by the service provider.

11. A method for converting a signature into an authorization for an item of value in lieu of cash, the method comprising:
transmitting a request, comprising a digitized signature and an amount requested, to a service provider;
receiving an authorization command from the service provider to permit the user to use the amount requested; and
printing an authorization for the user.

12. The method of claim 11, wherein the authorization comprises a printed barcode.

13. The method of claim 11, wherein the authorization permits the user to use the amount for postage, and wherein printing further includes:
printing the authorization for use as postage on an piece of mail.

14. The method of claim 11, wherein the authorization constitutes a coupon in the requested amount, and wherein the method further includes:
printing the authorization for use as a coupon.

15. A method for converting a signature into an authorization for an item of value in lieu of cash, the method comprising:
receiving a request comprising a digitized signature and an amount requested by a user;
determining if the signature is valid;
determining if the requested amount if approved for the user; and
transmitting an authorization command to permit the user to use the requested amount if the requested amount is approved.

16. The method of claim 15, wherein receiving includes receiving a PIN number, and wherein determining further includes:
validating the transmitted PIN number.

17. The method of claim 15, wherein the method includes:
generating an authorization command for printing a unique barcode.

18. A system for converting a signature into an authorization for an item of value in lieu of cash, the method comprising:
means for transmitting a request comprising a digitized signature and an amount requested by the user to a service provider with whom the user has an account;
means for authorizing the use of the value requested by the user; and
means for generating for the user an authorization allowing the user to spend in the amount authorized.

19. The apparatus of claim 18, further including:
a scanner to scan a user's signature to produce a digitized signature.

20. The apparatus of claim 18, further including:
one of a pressure sensitive signature pad and a digital pad to produce a digitized signature.

21. The apparatus of claim 18, further including:
a facsimile machine for sending a digitized signature.

22. The apparatus of claim 18, further including:
means for comparing the digitized signature with a prior signature provided to the service provider by the user.

23. The apparatus of claim 18, further including:
an interface for transferring a PIN number to the service provider.

24. The apparatus of claim 23, further including:
means for validating the PIN number against a PIN number associated with the user's account.

25. The apparatus of claim 18, further including:
means for generating an authorization comprising a barcode.

26. The apparatus of claim 18, further including:
means for opening and maintaining user accounts with a service provider.

27. The apparatus of claim 18, further including:
a printer for printing a barcode authorization for use of the authorized amount as postage.

28. The apparatus of claim 18, further including:
a printer for printing a barcode authorization for use of the authorized amount as a coupon.

29. An apparatus for converting a signature into an authorization for an item of value in lieu of cash, the method comprising:
means for transmitting a digitized signature and an amount requested to a service provider with whom the user has an account;
means for receiving an authorization command from the service provider to permit the user to use the amount requested;
a printer for printing an authorization for the user.

30. The apparatus of claim 29, wherein the printer constitutes a printer for printing an authorization comprising a barcode for the user.

31. The apparatus of claim 30, wherein the printer constitutes a printer for printing postage on an piece of mail.

32. The apparatus of claim 30, wherein printer constitutes a printer for printing a coupon for a product.

33. An apparatus for converting a signature into an authorization for an item of value in lieu of cash, the method comprising:
means for receiving a digitized signature and an amount requested by a user;
means of validating the signature;
means of authorizing the use of the amount requested, if the signature is valid; and
means for transmitting an authorization command for use of the amount requested if authorized.

34. The apparatus of claim 33, further including:
means for validating a PIN number for the user.

35. The apparatus of claim 34, further including:
means for generating an authorization command for printing a unique barcode.
